(19) United States
(12) Patent Application Publication
(10) Pub. No.: US 2026/0349114 A1
(43) Pub. Date: Nov. 5, 2026

(54) IMAGING DEVICE AND METHOD THEREOF

(71) Applicant: ams-OSRAM Asia Pacific Pte. Ltd., Singapore (SG)

(72) Inventors: Giacomo COLZI, Rueschlikon (CH); Preethi PADMANABHAN, Rueschlikon (CH); Pierre-Yves TALOUD, Annecy le vieux (FR)

(21) Appl. No.: 19/125,315

(22) PCT Filed: Dec. 1, 2023
(86) PCT No.: PCT/EP2023/083915

§ 371 Date: Apr. 29, 2025

(30) Foreign Application Priority Data
Dec. 22, 2022 (DE) 10 2022 134 571.8

(51) Int. Cl. G01S 17/894; G01S 7/481; G01S 7/4865

(52) U.S. Cl. CPC G01S 17/894; G01S 7/4814; G01S 7/4865

(57) ABSTRACT

An imaging device comprises a light emission system configured to emit light in a field of view of the imaging device light according to a predefined light pattern. At least one pattern element of the predefined light pattern has a light intensity profile with a decaying intensity in at least one direction. A light detection system is configured to detect light in the field of view of the imaging device. The at least one direction corresponds to a direction of a baseline between the light emission system and the light detection system.

### TECHNICAL FIELD

The present disclosure relates generally to an imaging device configured to emit light according to an adapted light pattern, and methods thereof (e.g., a method of carrying out a depth-measurement).

### BACKGROUND

In general, devices capable of capturing three-dimensional (3D) information within a scene are of great importance for a variety of application scenarios, both in industrial-as well as in home-settings. Application examples of 3D-sensors may include facial recognition and authentication in modern smartphones, factory automation for Industry 5.0, systems for electronic payments, augmented reality (AR), virtual reality (VR), internet-of-things (IOT) environments, and the like. Various technologies have been developed to gather three-dimensional information of a scene, for example based on time-of-flight of emitted light, based on structured light patterns, or based on stereovision. Improvements in 3D-sensors may thus be of particular relevance for the further advancement of several technologies.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1A shows a time-of-flight sensor in a schematic representation, according to

FIG. 1B shows a series of graphs related to a pile-up effect in light detection, according to various aspects;

FIG. 1C shows a series of graphs related to a distance-dependent active pixel masking effect in light detection, according to various aspects;

FIG. 2A shows an imaging device including a light emission system in a schematic representation, according to various aspects;

FIG. 2B shows a baseline between a light emission system and a light detection system of the imaging device, according to various aspects;

FIG. 2C shows the emission of a pattern element having an adapted light intensity profile in a schematic representation, according to various aspects;

FIG. 2D shows possible configurations of a light pattern element, according to various aspects;

FIG. 2E shows pixel masking at the light detection system in a schematic representation, according to various aspects;

FIG. 3A shows a light emission system in a schematic representation, according to various aspects;

FIG. 3B shows a superposition of light to create an intensity profile in a schematic representation, according to various aspects; and

FIG. 4A, FIG. 4B, and FIG. 4C each shows a respective approach to emit light according to a predefined pattern in a schematic representation, according to various aspects.

### DESCRIPTION

The following detailed description refers to the accompanying drawings that show, by way of illustration, specific details and aspects in which the invention may be practiced. These aspects are described in sufficient detail to enable those skilled in the art to practice the invention. Other aspects may be utilized and structural, logical, and electrical changes may be made without departing from the scope of the invention. The various aspects are not necessarily mutually exclusive, as some aspects may be combined with one or more other aspects to form new aspects.

Various strategies exist to implement active 3D-sensing, such as via structured light, active stereovision, or time-of-flight systems. In general, each of these techniques allows generating or reconstructing three-dimensional information about a scene, e.g., as a three-dimensional image, a depth-map, or a three-dimensional point cloud. For example, 3D-sensing allows determining information about objects present in the scene, such as their position in the three-dimensional space, their shape, their orientation, and the like. Exemplary applications of active 3D-sensing include their use in automotive, e.g., to assist autonomous driving, and in portable devices (e.g., smartphones, tablets, and the like) to implement various functionalities such as face or object recognition, autofocusing, gaming activities, etc. In this framework, time-of-flight sensors may provide an attractive solution in view of their compact configuration, fast response time (e.g., compared to structured light imaging and stereovision), and high accuracy and resolution.

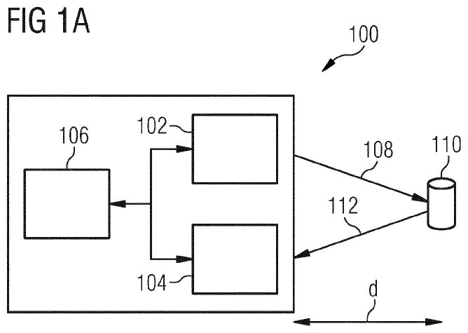

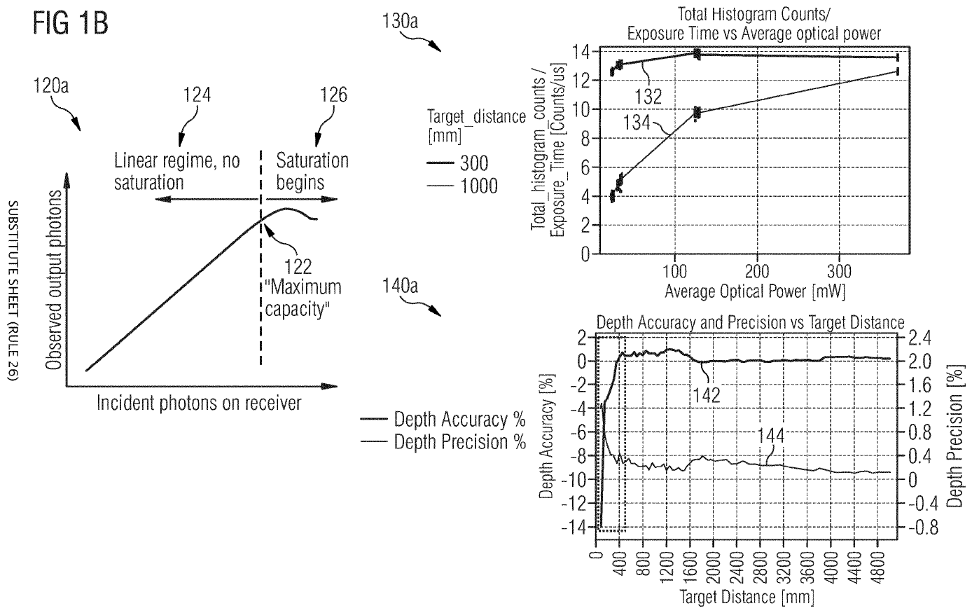

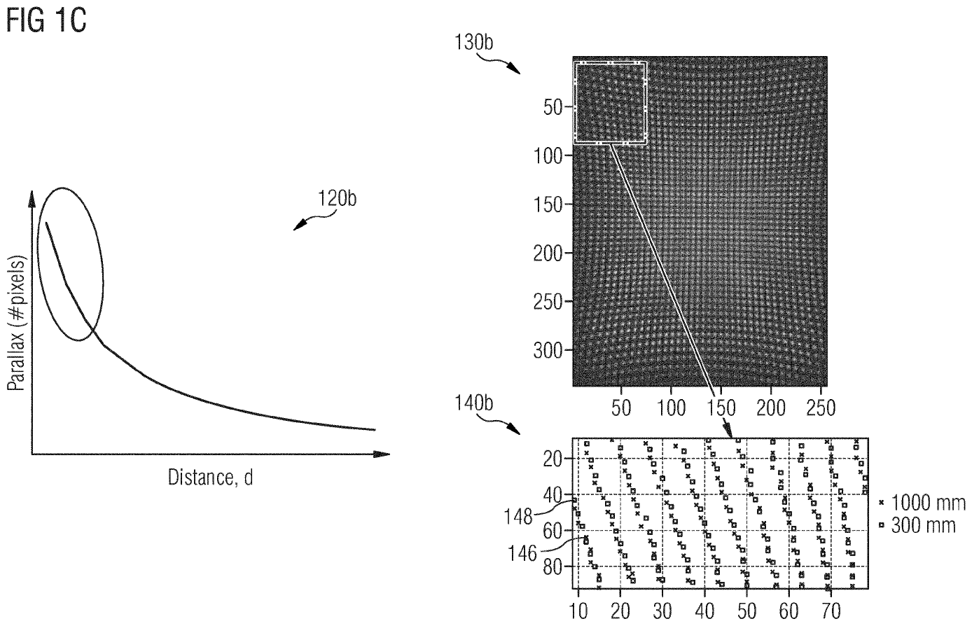

The typical request from the market is an optimization of the power consumption together with a maximization of the attainable sensor range, and higher resolutions. This holds especially true in the context of LIDARs and direct time-of-flight (dTOF) depth-sensors. Technological developments may thus be aimed at “squeezing out” high power from the illuminator to extend the distance range of the sensing device. However, the increase in power may lead to undesired effects when use cases involving shorter imaging distances are considered, such as a diverging (1/d) dot shift behavior, which makes it challenging to follow a dot image in the sensor, paired with another diverging behavior in the acquired intensity (1/d²). These effects are illustrated in FIG. 1B and FIG. 1C.

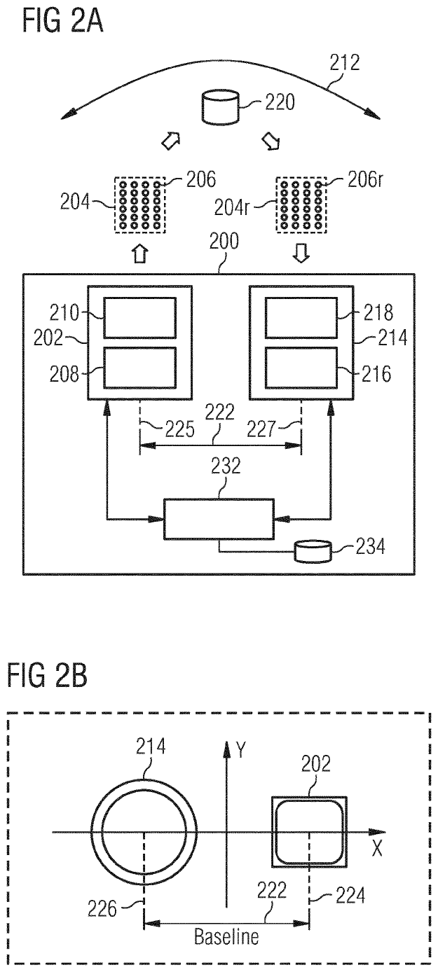

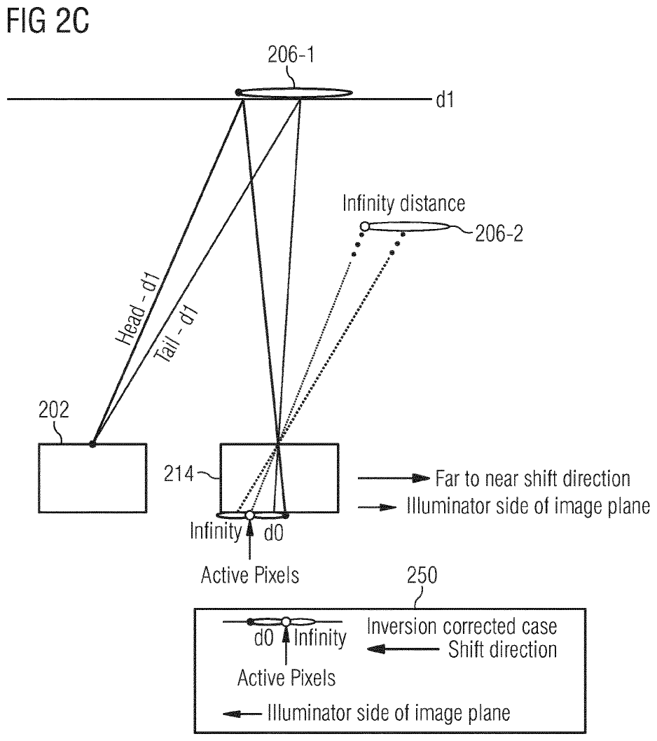

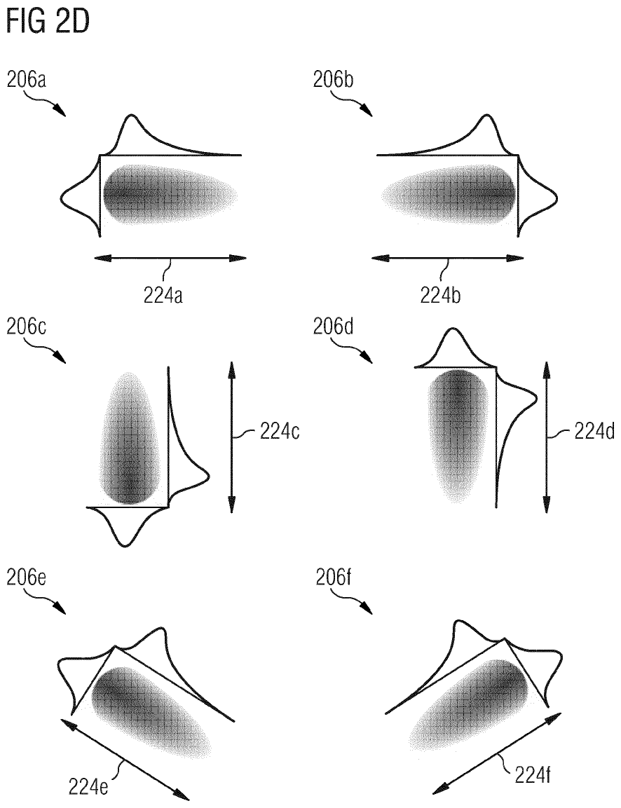

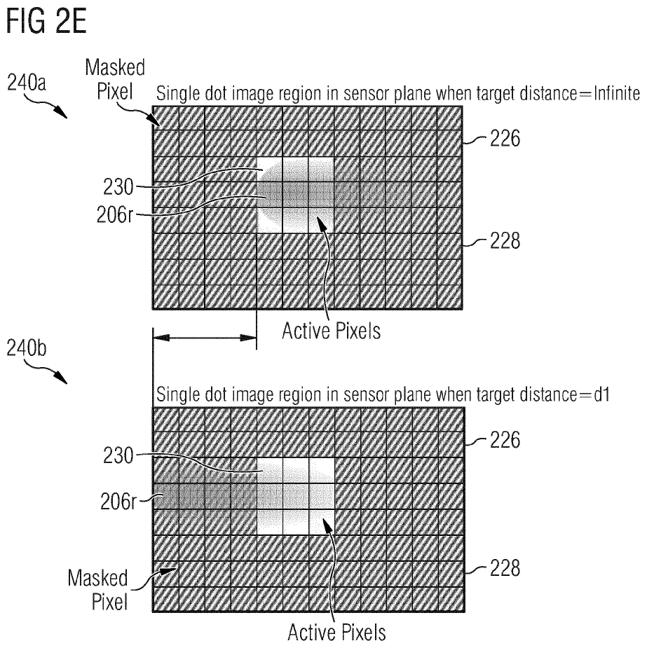

FIG. 1A shows a time-of-flight sensor 100 in a schematic view, according to various aspects. In general, the basic principles of time-of-flight measurements, as well as basic hardware/software components of a time-of-flight sensor, are known in the art. A brief description is provided herein to introduce aspects relevant for the present disclosure. FIG. 1A illustrates the general operation of a time-of-flight sensor 100. A detailed description of the adapted configuration of an imaging device will be provided in relation to FIG. 2A to FIG. 2E.

The time-of-flight sensor 100 may include, in general, a light emission system 102, a light detection system 104, and a processing circuit 106. As an abridged overview, the time-of-flight sensor 100 may be configured to determine the distance d at which an object 110 is located with respect to the sensor 100 by emitting light 108 and measuring the time it takes for the emitted light 108 to hit the object 110 and be reflected back (as reflected light 112) to the sensor 100. The light emission system 102 may thus be configured to emit a light signal 108 towards the field of view of the time-of-flight sensor 100. The emitted light signal 108 may hit an object 110 in the field of view, and at least part of the emitted light may be reflected back towards the time-of-flight sensor 100. The light detection system 104 may receive and detect a reflected light signal 112 corresponding to the back reflection of the emitted light signal 108, and the processing circuit 106 may be configured to calculate the time-of-flight and the distance d based on the reflected light signal 112. The object 110 may be any type of target in the field of view of the sensor 100, e.g. any type of inanimate object or animate object, such as a car, a tree, a traffic sign, an animal, a person, etc.

In general, a time-of-flight sensor 100 may be configured as a direct time-of-flight (DTOF) sensor, or as an indirect time-of-flight (ITOF) sensor.

In an ITOF configuration, the emitted light signal 108 may be a continuous light signal having a predefined modulation, such as an amplitude modulation. At the receiver side, the processing circuit 106 may determine a phase shift between the modulation of the emitted light signal 108 and a modulation of the received light signal 112. The processing circuit 106 may then convert the phase shift into a corresponding distance d using the formula d=(c*φ)/(2*2π*m), where φ is the phase shift, c is the speed of light in a given medium (e.g., air in a common use case, or water, as examples) and m is the modulation frequency. An ITOF configuration may be preferred in the context of three-dimensional imaging as it allows capturing more data points compared to a DTOF approach. However it suffers from some limitations in view of the long integration time, possible ambiguities due to phase wrapping, and the difficulty in distinguishing multiple reflected signals. In particular it may be more difficult to separate a signal originating from cover glass from a signal originating from a close object.

In a DTOF configuration, the light signal 108 may include a light pulse, and the processing circuit 106 may be configured to carry out a timing measurement to measure a time difference between the emission of the light pulse and the reception of the reflected light pulse back at the sensor 100. From the time difference At, the processing circuit 106 may be configured to calculate the distance d at which the object 110 is located via the formula d=Δt*c/2, where c is the speed of light in the medium (e.g., air), and the factor 1/2 is to take into account the round-trip from the sensor 100 to the object 110 and back to the sensor 100, similarly to the factor 2 used in the ITOF equation above. The processing circuit 106 may be configured to adjust the calculated distance by using one or more correction factors, e.g. to take into account effects of the optics of the time-of-flight sensor 100 as an example. A DTOF sensor may thus have a simple architecture, e.g. using a time-to-digital converter to measure the time difference between a start signal representing the emission of the light signal 108 and a stop signal representing the arrival time of the reflected light signal 112.

In a conventional DTOF scheme, the light emission system 102 may emit a laser pulse (e.g., a VCSEL pulse) at a fixed frequency that matches the maximum distance (illustratively, the maximum detectable range). During a given integration time, receiver pixels at the receiver side, e.g. single-photon-avalanche-diodes (SPADs), may accumulate photon counts, e.g. in a histogram with a fixed number of bins. After the integration is completed, the histogram may have a peak marking the position of the object. Illustratively, the arrival time of photons on a light sensor may be recorded, and the time-of-flight of the photons may be derived knowing the corresponding emission time.

FIG. 1B and FIG. 1C each shows a respective series of graphs 120a, 130a, 140a, 120b, 130b, 140b illustrating a distance-related effect occurring in light-based detection, for example in the context of distance-measurements based on time-of-flight.

A first effect, illustrated in FIG. 1B, may be due to a pile-up (illustratively, a saturation) occurring at short distances. The intensity of the light received on the light sensor (e.g., on a camera) may be inversely proportional to the square power of the distance (1/d²) from which the light is received, illustratively the distance d at which an object reflecting the emitted light is located, assuming that the object is uniformly lit and covers completely the subset of the field of view that the individual light sensor element sees at any considered distance d. In general, high power driving conditions may be desirable, as they enable longer distance detection, as mentioned above. However, in view of the inverse dependence of the intensity to the distance, the receiver sensor may have a maximum receiving capacity 122 (as illustrated schematically in the graph 120a), defining a minimum distance below which the sensor saturates.

Illustratively, for longer distances, the photons incident on the light sensor may be correctly observed (and detected), so that the light sensor may be in a linear regime 124, with no saturation. For shorter distances, the light sensor may saturate, so that not all the photons incident on the light sensor are observed, and the light sensor may be in a saturated regime 126. In a time-of-flight sensor, the pile-up effect may cause nonlinearities and temporal distortion of the received peak, potentially enhancing the impact of blooming and multipath false detections, in addition to saturation. The saturation effect may be especially relevant at short distances, as there is more power captured by the light sensor. The saturation effect may lead to under-estimating the distance at which the object 110 is located.

The graphs 130a and 140a illustrate that for increasing average optical power, the photon counts saturate and the accuracy degrades at short distances, as visible for the data points 132 related to a target at 300 mm distance, compared to the data points 134 related to a target at 1000 mm distance. Illustratively, the graph 130a shows nonlinearity and saturation of number of detected events plotted against the illuminator average optical power. At short distances, a temporal distortion of the acquired peak may occur, and the distortion of the detected peak shape may cause depth under-ranging (down to −14% relative inaccuracy in the exemplary case in FIG. 1B). The graph 140a shows that the accuracy 142 of the depth measurement decreases at short distances and increases for longer distances, whereas the precision 144 of the depth measurement may be higher at short distances. In this context, the precision may be defined as the relative standard deviation of depth over repeated acquisitions, so that a higher standard deviation indicates a less reproducible measurement.

In general, to cover the field of view of a time-of-flight sensor, a plurality of light pulses may be emitted. As an example, a direct time-of-flight measurement may include emitting a dot pattern (illustratively, including a light pulse at each dot) and measuring for each dot the respective round-trip time. Such type of measurement may suffer from the effect illustrated in FIG. 1C, the so-called distance-dependent active pixel masking. The receiver sensor pixels may be configured or controlled in such a way that only the ones matching the emitted pattern are active, thus reducing the device sensitivity towards spurious light sources that illuminate regions not matching the ones illuminated by the pattern (e.g., to improve ambient light rejection). Illustratively, a mask may be applied to the receiver pixels to prevent light from being detected in regions of the receiver that do not correspond to the emitted light pattern. However, as shown in the graph 120b, the parallax effect causes the pattern image on the sensor to shift proportionally to 1/d, so that such effect may be more relevant at short distances. Such “baseline effect” induces a shift of the projected pattern depending on the distance. This may also be seen in the graphs 130b, 140b, in which the dot centers detected for a target at 300 mm distance (indicated by the squares 148) presents a shift with respect to the dot centers at 1000 mm distance (indicated by the crosses 146). The dot shift may pose a problem in view of the masking of the pixels, since the shift may cause certain masks to be not suitable or no longer suitable for certain distance ranges. Conventional devices, mainly optimized for long range (compared to sensor baseline) detection, often switch between a given number of recorded masks, each activated in different integrating windows of the sensor (covering different distance intervals). This solution is however more and more difficult to implement efficiently at shorter distances, given the diverging behavior of the dot shift. Thus, in theory, and assuming that incrementing the number of integrating windows is feasible, a high number of masks should be made available to cover the different scenarios but, in general, only a limited number of different masks may be stored in a sensor to compensate for such an effect.

In general, existing solutions for imaging devices (e.g., for time-of-flight sensors) address only one of the effects discussed in relation to FIG. 1B and FIG. 1C at a time, i.e. either short-distance saturation/pile-up or distance-dependent active masking. For example, an existing approach may combine a periodic structured light pattern depth sensor together with a time-of-flight sensor. This approach makes use of the possibility of computing a time-of-flight based depth map to remove the phase ambiguity in the feature matching, but however leads to an increased complexity due to the employment of two different sensing techniques.

The present disclosure may be related to an imaging strategy that addresses the limited intensity dynamic range for different target distances acquired with the same driving conditions and integration time settings. In various aspects, the detection may be carried out in a defined sub-range using a fixed mask. In particular, the present disclosure may be based on engineering an emitted light pattern (e.g., an emitted dot pattern) to compensate for the distance-related shift, while at the same time exploiting the distance-related shift to reduce or prevent saturation of the light sensor.

The present disclosure may be based on the realization that the distance-related shift, which may be usually considered to be a detrimental effect (as discussed in relation to FIG. 1C), may be actually exploited to address the limited dynamic range and/or nonlinearities in image sensors that cause either saturation or, in the exemplary case of time-of-flight sensors, under-ranging due to pile-up (as discussed in relation to FIG. 1B). The approach described herein provides thus adapting the spatial distribution of the intensity of the pattern to the target distance, thus allowing to exploit the optimal dynamic range of the sensor.

According to the approach described herein, the elements (e.g., the dots) of a light pattern may be provided with a non-uniform intensity, e.g. with an intensity that gradually decreases along one or more spatial directions. The light pattern may be configured such that the intensity of a pattern element may decrease along the direction of an expected distance-related shift of the pattern elements. The adapted intensity may provide that in case a relatively large shift occurs (e.g., at a short distance), less intensity is received at a light sensor in view of the decreasing intensity of the pattern element along the shift-direction (illustratively, considering a masking of the sensor pixels). The approach described herein thus tackles the problem at the system level, in the framework of a camera(s) and illuminator sensor system, without the need for combining two different depth acquisition methods.

According to various aspects, an imaging device may include a light emission system configured to: emit, in a field of view of the imaging device, light according to a predefined pattern, wherein at least one (e.g., each) pattern element of the predefined pattern has a light intensity profile with a decaying intensity in at least one direction corresponding to a direction of an expected spatial shift of the at least one pattern element.

The term “direction” may be used in the present disclosure to describe, illustratively, an axis or a line in a three-dimensional (or two-dimensional) space, without including or implying a specific orientation. Illustratively, the expression “along a direction” may describe a feature or a property that occurs along a line, without including or implying the orientation towards which the feature or property is pointing. By way of illustration, along a certain direction there may be two possible orientations (e.g., left and right, up or down, etc.). Unless specified otherwise, the expression “along a direction” may describe a feature or a property that may occur in one of the two possible orientations along that direction (illustratively, along that axis, or line).

In general, the distance-related shift of a pattern element may be along the baseline between the camera and the illuminator. The “baseline” may be a distance (e.g., a center-to-center distance) between the camera and the illuminator. The “baseline” may illustratively be or indicate a distance between a line passing through the center of the illuminator and a line passing through the center of the camera, e.g. may be or indicate a distance between a line crossing the optical axis of the illuminator and a line crossing the optical axis of the camera. A device may also have more than one baseline, e.g. in case the device includes a plurality of cameras and/or a plurality of illuminators. A “baseline” may also be referred to herein as baseline distance.

According to various aspects, the emitted light pattern may be configured according to the baseline between the light sensor and the illuminator, e.g. at least one (e.g., each) pattern element may have a light intensity profile with an intensity decaying along the direction of the baseline between the light emission system and a light detection system of the imaging device. Illustratively, the specific engineering of the pattern distribution may be combined with a knowledge of the camera-illuminator baseline. The pattern elements (e.g., the dots) may be configured to have a power law decay tail along a specific direction defined by the baseline. The camera-illuminator baseline may be configured (e.g., designed) such that the element shift (e.g., the dot shift) together with the power law decay compensates the 1/d² increase in intensity.

The approach described herein may include, in various aspects, matching the camera-illuminator geometrical baseline, the camera effective focal length, and the pattern (both the inter-dot distance, and individual dot distribution), to predicted use-case distances interval and to the (macro-) pixel size of the sensor.

According to various aspects, an imaging device may include: a light emission system configured to emit, in a field of view of the imaging device, light according to a predefined pattern, wherein at least one (e.g., each) pattern element of the predefined pattern has a light intensity profile with a decaying intensity in at least one direction (and, in some aspects, an elongated shape in the at least one direction); and a light detection system configured to detect light in the field of view of the imaging device, wherein the at least one direction corresponds to a baseline (illustratively, a direction of a baseline) between the light emission system and the light detection system.

According to various aspects, a method of carrying out a depth-measurement may be provided, the method including: emitting light according to a predefined pattern, wherein at least one (e.g., each) pattern element of the predefined pattern has a light intensity profile with a decaying intensity in at least one direction corresponding to a direction of an expected spatial shift of the at least one pattern element; and activating one or more receiver pixels in accordance with the predefined pattern of the emitted light.

According to various aspects, the light emission system may be configured to emit light according to the predefined pattern by superimposing a plurality of patterns. Illustratively, a pattern element may result from the superposition of a plurality of pattern elements that provide engineering the shape and the light intensity distribution of the pattern element to match the expected shift in a certain distance range. The superposition of a plurality of patterns may allow engineering the individual pattern elements in a simple, yet efficient manner that may be implemented optically and/or electronically, as discussed in further detail below. For example, the element shape may be controlled via a suitable design of micro-lens array (MLA) tiles, and/or via a suitable design of emitter pixels (e.g., a VCSEL array), and/or via a suitable design of a prism array. A plurality of patterns that are partially overlapped may be generated, which contribute to define the desired element shape (e.g., dot shape).

In the context of the present disclosure, particular reference may be made to the application of the strategy described herein for depth-measurements based on time-of-flight. Illustratively, particular reference may be made to the scenario in which the imaging device is a time-of-flight sensor. These application may be the most relevant use case for the approach described herein. It is however understood that detection based on an adapted light pattern as discussed in the following may in general be applied to imaging systems in which saturation effects may be present, e.g. any imaging system with “masking” at the receiver side. Other examples may include the implementation of the approach for an ordinary camera sensor, e.g. used in structured light sensors or for simple image acquisition.

FIG. 2A shows an imaging device 200 in a schematic representation, according to various aspects. The imaging device 200 may include a light emission system 202 configured to emit light according to the adapted approach described herein, e.g. configured to emit light according to an adapted light pattern. In an exemplary configuration, the imaging device 200 may be a time-of-flight sensor, e.g. a direct time-of-flight sensor, e.g. the imaging device 200 may be an adapted configuration of the time-of-flight sensor 100 described in FIG. 1A. An “imaging device” may also be referred to herein as “detection device”, or “3D-sensor”.

It is understood that the representation of the imaging device 200 in FIG. 2A may be simplified for the purpose of illustration, and the imaging device 200 may include additional components with respect to those shown. As examples, the imaging device 200 may further include one or more filters to reduce noise, one or more amplifiers, and the like.

In general, the imaging device 200 may be implemented for any suitable three-dimensional sensing application. As examples, the imaging device 200 may be used in a movement tracker (e.g., an eye tracker), in a vehicle, in an indoor monitoring system, in a smart farming system, in an industrial robot, and the like.

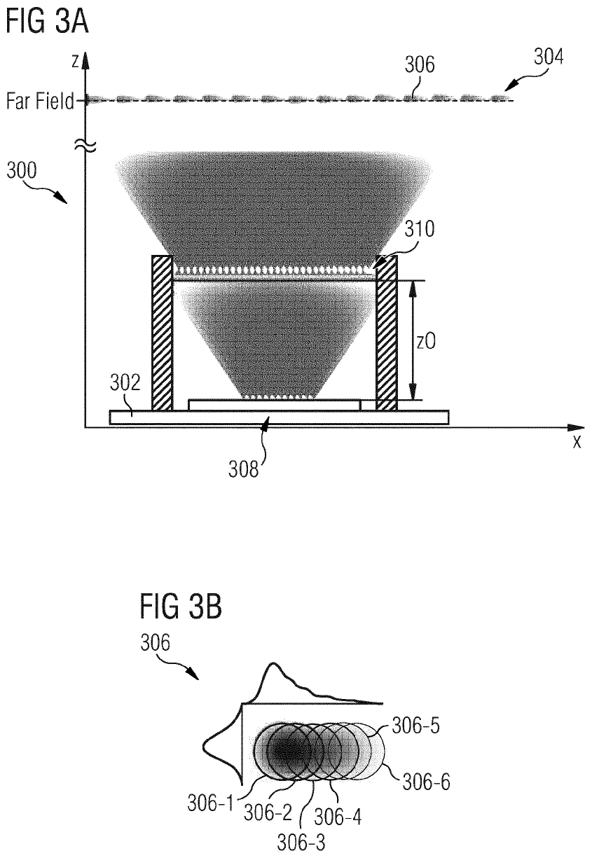

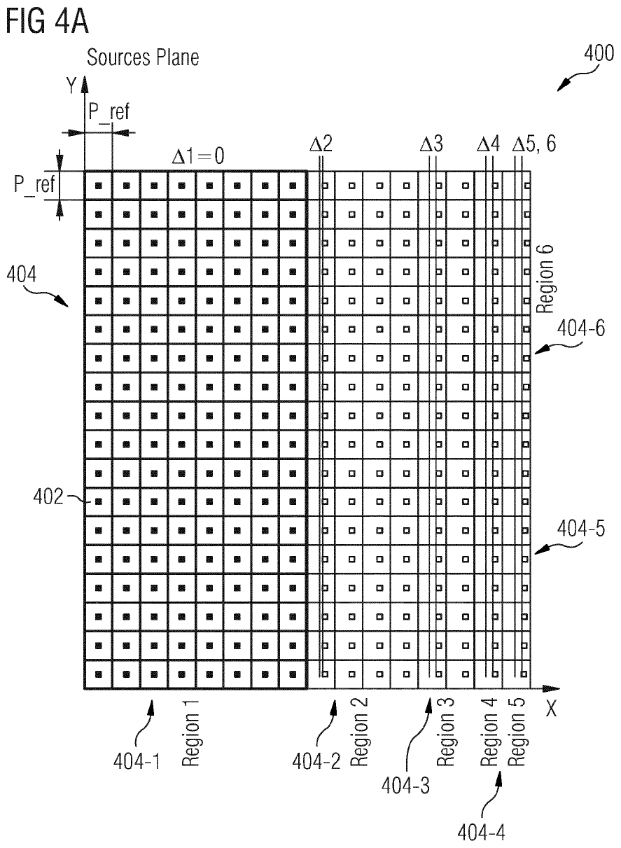

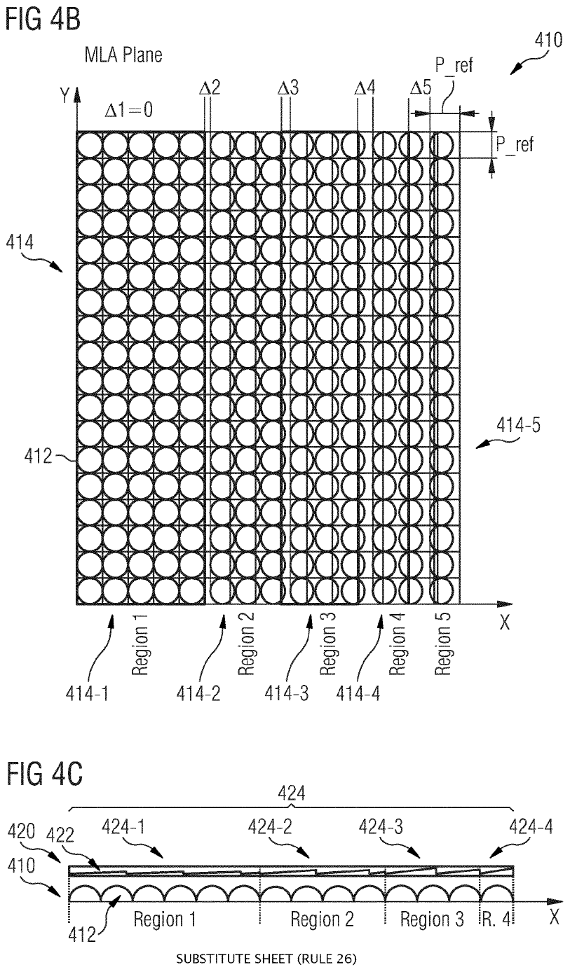

The light emission system 202 may be configured to emit light, e.g. in a field of view 212 of the imaging device 200. In general, the light emission system 202 may include an illuminator 208 (e.g., a light source) and emitter optics 210, which will be described in further detail in relation to FIG. 3A to FIG. 4C, and which may be configured or controlled to emit light according to the strategy outlined herein. The imaging device 200 may further include a light detection system 214 configured to receive light, e.g. from the field of view 212. Illustratively, the light detection system 214 may be configured to collect and detect light from the field of view 212. In general, the light detection system 214 may include a light sensor 216 and receiver optics 218, described in further detail below. The light sensor 216 may be an imaging sensor, and the receiver optics 218 may be imaging optics (e.g., including one or more lenses, and/or one or more mirrors, and/or one or more filters, and/or the like). The light emission system 202 may also be referred to herein as illuminator module. The light detection system 214 may be, for example, a camera, and may also be referred to herein as camera module.

The light source 208 may be configured to emit light having a predefined wavelength, for example in the visible range (e.g., from about 380 nm to about 700 nm), infrared and/or near-infrared range (e.g., in the range from about 700 nm to about 5000 nm, for example in the range from about 860 nm to about 1600 nm, or for example at 905 nm or 1550 nm), or ultraviolet range (e.g., from about 100 nm to about 400 nm). In some aspects, the light source 208 may be or may include an optoelectronic light source (e.g., a laser source). As an example, the light source 208 may include one or more light emitting diodes. As another example the light source 208 may include one or more laser diodes, e.g. one or more edge emitting laser diodes or one or more vertical cavity surface emitting laser (VCSEL) diodes. In various aspects, the light source 208 may include a plurality of emitters (e.g., a plurality of VCSELs), e.g. the light source 208 may include an emitter array having a plurality of emitters. For example, the plurality of emitters may be or may include a plurality of laser diodes. For example, the light source 208 may include an array of sources of coherent light. In various aspects, the light source 208 may be a projector.

The light sensor 216 may be configured to be sensitive for the emitted light, e.g. may be configured to be sensitive in a predefined wavelength range, for example in the visible range (e.g., from about 380 nm to about 700 nm), infrared and/or near infrared range (e.g., in the range from about 700 nm to about 5000 nm, for example in the range from about 860 nm to about 1600 nm, or for example at 905 nm or 1550 nm), or ultraviolet range (e.g., from about 100 nm to about 400 nm). The light sensor 216 may include one or more light sensing areas, for example the light sensor 216 may include one or more photo diodes. As examples, the light sensor 216 may include at least one of a PIN photo diode, a PN photo diode, an avalanche photo diode (APD), a single-photon avalanche photo diode (SPAD), or a silicon photomultiplier (SiPM). For example, for time-of-flight measurements, single-photon avalanche photo diodes (SPADs) allow generating a strong (avalanche) signal upon reception of single photons impinging on the photo diodes, thus providing a high responsivity and a fast optical response. In general, for time-of-flight measurements, the light sensor 216 may be configured to store time-resolved detection information (for DTOF) and/or phase-resolved information (for ITOF). In various aspects, the light sensor 216 may include a plurality of receiver pixels (also referred to as sensor pixels), e.g. the light sensor 216 may include an emitter array having a plurality of receiver pixels. For example, the plurality of receiver pixels may be or may include a plurality of photo diodes (e.g., a plurality of SPADs). As another example, a receiver pixel may be configured as a Charged Coupled Device (CCD) or Complementary Metal Oxide Semiconductor (CMOS) light sensitive pixel. For example, PN photo diodes, PIN photo diodes, and SPADs may be implemented using CMOS processes.

The field of view 212 of the imaging device 200 may extend along three directions, referred to herein as field of view directions. Illustratively, the first field of view direction may be a first direction along which field of view 212 has a first lateral extension (e.g., a first angular extension), and the second field of view direction may be a second direction along which the field of view 212 has a second lateral extension (e.g., a second angular extension). In some aspects, the first field of view direction may be a horizontal direction (e.g., a horizontal angular field of view), and the second field of view direction may be a vertical direction (e.g., a vertical angular field of view). It is however understood that the definition of first field of view direction and second field of view direction may be arbitrary. The first field of view direction and the second field of view direction may be orthogonal to one another, and may be orthogonal to a direction along which an optical axis of the light emission system 202 and/or an optical axis of the light detection system 214 is/are aligned (e.g., the optical axis may be aligned along a third field of view direction). The third field of view direction may illustratively represent a depth of the field of view 212.

In general, the field of view 212 may be the angular range within which the imaging device 200 may operate, e.g. the angular range within which the imaging device 200 may carry out an imaging operation (e.g., a depth-measurement). In some aspects, the field of view 212 may be or correspond to a field of illumination of the light emission system 202 and/or to a field of view of the light detection system 204. The field of view 212 may illustratively be a detection area of the imaging device 200.

According to various aspects, the light emission system 202 may be configured to emit light according to a predefined pattern 204 (received as reflected light, e.g. reflected pattern 204r, at the light detection system 214). The predefined pattern 204 may in general include one or more pattern elements 206. In general, the strategy described herein may be applied for detection using a single pattern element 206, or for detection using a plurality of pattern elements 206. In the following, reference may be made to a pattern 204 including a plurality of pattern elements 206, as this may be the most relevant scenario (illustratively, to enable a time-efficient coverage of the field of view 212 of the imaging device 200). It is however understood that the aspects described in relation to a pattern 204 including a plurality of pattern elements 206 may apply in a corresponding manner to detection based on a single emission.

The term “pattern element” may be used herein to describe a local spatial distribution of light intensity, e.g. within a pattern. A “pattern element” may illustratively be a light pattern (or sub-pattern) having a predefined spatial distribution of the intensity. Further illustratively, a “pattern element” may be a portion (or sub-portion) of the pattern, e.g. a pattern portion or sub-portion. A “pattern” or “light pattern” may thus be or include a spatial distribution of light intensity, which may be sub-divided into one or more sub-portions or sub-patterns referred to herein as “pattern elements”. In this regard, the predefined pattern 204 may include one or more light patterns 206, each having a predefined spatial distribution of the respective light intensity.. A “pattern element” may also be referred to herein as “light pattern element”. In various aspects, considering an angular extension of the field of view 212 of the imaging device 200, a “pattern” or “light pattern” may be or include an angular distribution of light intensity. Illustratively, spatial coordinates of the distribution of the light intensity may correspond to respective angular coordinates of the distribution of the light intensity, and vice versa.

As an exemplary configuration, the pattern 204 may include a grid (in other words, a matrix) of pattern elements 206. Illustratively, in this scenario, the pattern 204 may include a plurality of pattern elements forming a two-dimensional array, e.g. in a plane defined by the first and second field of view directions (e.g., a plane defined by the horizontal and vertical field of view directions). The pattern 204 may include a number M of rows and a number N of columns, with M and N being integer numbers equal to or greater than 1. The number M of rows and the number N of columns may be selected depending on the desired area of the field of view 212 to be illuminated, and depending on the desired distance between the pattern elements 206. Thus, M may be equal to N, or M may be greater than N, or M may be smaller than N. It is however understood that the pattern 204 may have any suitable spatial configuration, e.g. with a regular or irregular disposition of the pattern elements 206.

In general, the pattern elements 206 may be spaced from one another, e.g. there may be an element-to-element distance between adjacent pattern elements 206, for example along the first field of view direction and/or along the second field of view direction. The distance between adjacent (illustratively, neighboring) pattern elements 206 may be adapted taking into account the extension of the respective intensity profile, as discussed in further detail below.

In various aspects, the light emission system 202 may be configured to emit the pattern elements 206 simultaneously, e.g. as a flash-illumination of the field of view 212. For example, the illuminator 208 may include an array of emitters that allow emitting light as a plurality of pattern elements 206. This configuration may provide a more time-efficient detection over the field of view 212. In other aspects, the light emission system 202 may be configured to emit the pattern elements 206 in sequence, e.g. one after the other. This configuration may provide a simpler extraction of information at the receiver side, in view of the reduced data rate compared to the scenario with a simultaneous illumination of the field of view 212. The emission of individual pattern elements may also allow to allocate more emitted power and/or area for each acquisition, hence increasing the maximum detectable depth.

The pattern elements 206 may, in general, be configured to enable compensating for a distance-related shift that may occur during propagation and reflection of the emitted light in the field of view 212 (e.g., reflection by an object 220 present in the field of view 212). A pattern element 206 (e.g., at least one, or each pattern element 206 of the predefined pattern 204) may have a light intensity profile with a decaying intensity along at least one direction. Illustratively, the light emission system 202 may be configured to emit a pattern element 206 with a light intensity that decreases (illustratively, fades) along at least one direction. The at least one direction may be in a plane orthogonal to an emission direction of the light, e.g. the at least one direction along which the light intensity decreases may lie in a plane defined by the first and second field of view directions (illustratively, the x-y plane).

According to the strategy described herein the at least one direction may correspond to a direction of an expected spatial shift of the pattern element 206 (e.g., of each pattern element 206). Illustratively, the light intensity profile of a pattern element 206 may be configured according to a parallax effect defined by the respective position of the light emission system 202 and light detection system 214. A pattern element 206 may thus have a light intensity that (gradually) decreases along the spatial direction along which a spatial shift of the pattern element 206 may occur upon propagation/reflection.

A pattern element 206 may in general have any suitable shape (illustratively, any suitable spatial distribution) that allows obtaining a decaying intensity profile. In a preferred configuration, which may be implemented in a simple and efficient manner either optically or electronically (see also FIG. 3A to FIG. 4C), a pattern element 206 may have a dot-like shape, e.g. an elongated dot shape (illustratively, a substantially elliptical shape). Such shape may be achieved by superimposing a plurality of individual circular light dots, as discussed in further detail below. In some aspects, the predefined pattern 204 may thus be or include a dot pattern including one or more elongated dots. The shape of a pattern element 206 is however, in principle, not limited to a dot-like shape. Other examples may include a rectangular shape, a triangular shape, etc.

In general, a pattern element 206 may have an elongated shape (illustratively, an elongated profile) along the at least one direction, e.g. along the direction of the expected spatial shift. By way of illustration, a pattern element 206 may have a first portion (e.g., a head) with higher light intensity and a second portion (e.g., a tail) with lower light intensity, as also shown in FIG. 2D. Illustratively, the intensity profile of a pattern element 206 may be elongated in the at least one direction, e.g. a (first) lateral extension of the intensity profile along the at least one direction may be greater than a (second) lateral extension of the intensity profile along a further (second) direction orthogonal to the at least one direction. The elongated shape and the decreasing intensity allow compensating for the saturation effect occurring at short distances, as discussed in further detail below.

According to various aspects, the direction of the expected shift of a pattern element 206 may be defined by a baseline 222 between the light emission system 202 and the light detection system 214. Illustratively, the at least one direction along which the light intensity of a pattern element 206 decreases may be the direction formed by the baseline 222, e.g. the direction formed by a line 222 crossing the optical axis 225 of the light emission system 202 and the optical axis 227 of the light detection system 214.

The optical axis 225 of the light emission system 202 may be or correspond to the optical axis defined by the illuminator 208 and/or by the emitter optics 210. In a corresponding manner, the optical axis 227 of the light detection system 214 may be or correspond to the optical axis defined by the light sensor 216 and/or by the receiver optics 218 (e.g., the optical axis 227 may be the optical axis of a camera at the receiver side). The baseline 222 may be understood as an imaginary line orthogonal to the optical axes 225, 227. In general, the shift of emitted light may occur along a direction parallel to the baseline 222, so that the at least one direction along which the intensity of a pattern element 206 decreases may be parallel to the baseline 222.

The orientation (along the at least one direction) in which the light intensity of a pattern element 206 decreases may be selected according to the specific application and to the overall configuration of the imaging device 200. In general, the orientation in which the light intensity of a pattern element 206 decreases may be opposite to the orientation in which the image of the pattern element 206 shifts at the receiver side (e.g., on the light sensor 216) when the distance decreases. By way of illustration, with this “opposite” orientation, the active pixels at the receiver side may be illuminated by the head of the element at long distance (zero shift) and, as the target gets closer, the pattern element moves towards the direction pointed to by the head, so that the tail falls into the active pixel region (see also FIG. 2E).

The image may shift towards the illuminator side in a world-facing perspective (illustratively, looking from behind the camera with no image inversion). The tail of a pattern element 206 may thus point in the opposite direction, towards the light detection system 214 (e.g., to the camera). Therefore, in a preferred configuration, at the emitter side the at least one direction along which the intensity of a pattern element 206 decreases may be oriented pointing from the light emission system 202 towards the light detection system 214 (when facing the imaging device 200). Illustratively, the light emission system 202 may be configured to emit the pattern 204 such that the light intensity profile of a (e.g., each) pattern element 206 has a decreasing intensity along the baseline between the light emission system 202 and the light detection system 214 and pointing towards the light detection system 214.

Such configuration is illustrated in FIG. 2C, which shows the emission of an adapted pattern element 206-1 being imaged at a short(er) distance d1, and of an adapted pattern element 206-2 being imaged at infinity. The configuration outlined in the drawing, as an exemplary scenario, accounts for image inversion in a pinhole camera and produces the desired results. The head of the pattern element 206-1, 206-2 is represented as a black circle (full at d1, empty at infinity), and the decaying tail is represented as an ellipse (again, empty at infinity). At infinity, the camera rays are parallel to the illuminator rays. As shown in FIG. 2C, the pattern element 206-1, 206-2 may have a tail pointing towards the light detection system 214 upon emission. At the receiver side, the shift of the pattern element 206-1 may be related to the distance d1, as discussed above, and in case of inversion the imaged pattern element may have a tail pointing towards the light emission system 202. The optical inversion of the image may be corrected (for instance via software, to have a world-facing perspective of a produced depth map image), but the above given result holds, since both the pattern element orientation, and the shift direction are flipped, as shown in the inset 250.

The baseline 222 between the light emission system 202 and the light detection system 214 is also illustrated in FIG. 2B from the perspective of a front view of the imaging device 200. In various aspects, the light emission system 202 and the light detection system 214 may define a two-dimensional plane (a XY-plane), in which the illuminator 208 and the light sensor 216 (illustratively, the illuminator elements and camera elements) are disposed (e.g., mounted). For example, such two-dimensional plane may be parallel to a plane defined by the first and second field of view directions, which may provide a simple configuration for the detection (e.g., simpler calculations) or may be tilted with respect to the plane defined by the first and second field of view directions.

The light emission system 202 may emit light towards an emission direction orthogonal to the two-dimensional plane defined by the light emission system 202 and the light detection system 214. Illustratively, the emission direction may be a Z-axis orthogonal to the XY-plane. The emission direction may be parallel (e.g., substantially parallel considering manufacturing tolerances) to the optical axis 225 of the light emission system 202 and/or to the optical axis 227 of the light detection system 214. In various aspects, the at least one direction along which the intensity of a pattern element 206 decreases may be orthogonal to the emission direction, e.g. may lie in the two-dimensional plane defined by the light emission system 202 and the light detection system 214 (and, in some aspects, may be oriented pointing towards the light detection system 214). The baseline 222 may illustratively be along the X-axis passing simultaneously from the center of one of the illuminators (e.g., one of the projectors) and one of the cameras. The length of the baseline 222 may be adapted depending on the desired application, e.g. on the desired working distance. Only as a numerical example, the baseline 222 may have a length in the range from 0,25 cm to 5 cm, for example in the range from 0,5 cm to 2 cm, for example the baseline 222 may have a length of 1 cm or less.

FIG. 2D illustrates possible configurations of a pattern element 206a-206f in a schematic representation, according to various aspects. Illustratively, FIG. 2D shows possible shapes and intensity profiles of a pattern element 206 of the predefined pattern 204. The exemplary representation in FIG. 2D shows pattern elements 206a-206f with an intensity that decreases along a respective direction 224a-224f. It is however understood that, in principle, the intensity of a pattern element 206a-206f may be tailored along more than one spatial direction. For example, a pattern element 206 may have a light intensity profile with a light intensity decreasing along a first direction (e.g., parallel to the baseline 222) and a second direction (e.g., orthogonal to the first direction). As a further example, a pattern element 206 may have a light intensity profile with a light intensity decreasing in a star-like manner, e.g. along four spatial directions.

In general, the at least one direction 224a-224f along which the light intensity decreases may be selected according to the configuration of the imaging device 200, e.g. according to the arrangement of the light emission system 202 and light detection system 214. In a simple configuration, as shown for the pattern elements 206a, 206b, the at least one direction 224a, 224b may be parallel to the horizontal field of view direction (illustratively pointing towards the left-hand side or right-hand side). In other aspects, as shown for the pattern elements 206c, 206d, the at least one direction 224c, 224d may be parallel to the vertical field of view direction (illustratively pointing upwards or downwards). In other aspects, as shown for the pattern elements 206e, 206f, the at least one direction 224c, 224d may be at an angle with respect to the horizontal (or vertical) field of view direction, e.g. an angle greater than 0° and less than 90°, for example 45° or 60°.

In various aspects, a pattern element 206a-206f may have an intensity profile with a decaying tail in the at least one direction 224a-224f, and the intensity profile may have a (substantially) Gaussian-shape in a second direction orthogonal to the at least one direction 224a-224f. Illustratively, in the at least one direction 224a-224f the intensity profile may have a Gaussian shape with asymmetric tails, e.g. with a longer tail in the orientation in which the intensity decreases. Further illustratively, a pattern element 206a-206f may have an elongated intensity profile (e.g., with an elongated tail) in the at least one direction 224a-224f. A pattern element 206a-206f may have a maximum intensity around a first edge, and the intensity may gradually decrease down to a minimum intensity around (or at) a second edge opposite the first edge along the at least one direction 224a-224f (in the orientation in which the intensity decreases).

According to various aspects, the law according to which the intensity profile of a pattern element 206a-206f decreases may be adapted according to an expected behavior of the emitted light, e.g. according to the expected shift, and/or according to a configuration of the light detection system 214 (e.g., according to an expected intensity impinging onto the light sensor 216).

In a preferred configuration, the light intensity of a pattern element 206 may decay (illustratively, decrease) according to a power law with a predefined exponent, e.g., may decrease as 1/x″, where n may be an integer number. As an example, which provides an efficient compensation of the saturation effect at short distances, the light intensity of a pattern element 206 may decay according to 1/x₂. A decay according to a power law with a predefined exponent has been found to provide an efficient compensation of the saturation effect described in relation to FIG. 1B. It is however understood that, in principle, the light intensity of a pattern element 206 may also have another type of decaying behavior. As another example, the light intensity of a pattern element 206 may decrease according to a decaying exponential. As a further example, the light intensity of a pattern element 206 may decrease linearly.

According to various aspects, the light intensity profile of a pattern element 206 may be configured according to the baseline 222 between the light emission system 202 and the light detection system 214, e.g. may be configured according to the length of the baseline 222. As mentioned in relation to FIG. 1B, the intensity captured by the light detection system 214 (e.g., by a camera) may be proportional to 1/d₂. The spatial shift As of a pattern element 206 may be related to the baseline 222 (BL), illustratively to the length of the distance between the light detection system 214 and the light emission system 202, by the equation Δs=BL*f/d, where f is the effective focal length of the light detection system 214, e.g. the effective focal length of a camera. The intensity profile of a pattern element 206 may be configured taking into account these two effects. Illustratively, the intensity of a pattern element 206 may decrease according to a law that ensures that, upon a shift As, the intensity reaching the light sensor 216 of the light detection system 214 remains below a saturation threshold of the light sensor 216. Further illustratively, the intensity of a pattern element 206 may be configured such that in case the emitted light is reflected at a distance d from the imaging device 200, the intensity reaching the light sensor 216 has a value that compensates the increase given by 1/d² in view of the shift Δs.

Given a decaying tail distribution of the engineered pattern of 1/xⁿ, the part of the pattern element 206 that is imaged in the light sensor 216 (e.g., in the activated receiver pixels, as discussed below) may have an intensity, whose dependency from the distance d as a consequence of the shift is given by 1/(Δs)ⁿ=dⁿ/(BL*f)ⁿ. For n=2, as the target gets closer to the sensor, the 1/d² increment in intensity because of the distance, and the d²/(BL*f)² contribution may cancel each other to an intensity independent from distance, preventing pile-up or saturation effects. It is however understood that the n exponent may be also selected to have a different value, or a tail behavior different from a simple power law may be engineered to compensate additional effects that impact the pattern image intensity on the sensor, such as image defocus or distortions of the pattern at short range. According to various aspects, the decaying tail of the intensity of a pattern element 206 may be adapted to be sufficiently wide to ensure that the tail functional decay is not simply averaged out by integrating over the receiver pixels of the light sensor 216, e.g. over the pixel surface (or a macro-pixel, in cases like single-photon detector connected to an event combiner, such as an OR tree).

According to various aspects, the imaging device 200 may be configured to operate in a predefined distance range, e.g. in a distance range from a minimum imaging distance d_{MIN} and a maximum imaging distance d_{MAX}. As mentioned above, the baseline shift may cause the image of the pattern 204r acquired by the light detection system 214 to shift, compared to the pattern projected at infinity, by a quantity BL*f/d. The direction of such shift is towards the illuminator, as shown in FIG. 2C (illustratively, towards the illuminator side of the image plane). The pattern shift between the maximum and the minimum distances may thus be BL*f*(1/d_{MIN}−1/d_{MAX}). When d_{MAX} is sufficiently large compared to the baseline, this relationship may be approximated as d_{MAX}=infinite. When the target distance is d_{MAX}, the peak of the intensity distribution is imaged on the light sensor 216 (e.g., on the receiver pixels that are enabled), whereas for a different distance less than the maximum imaging distance, d<d_{MAX}, the intensity distribution of the (shifted) pattern element 206 may compensate the increased intensity due to the closer distance. According to various aspects, the light intensity profile of a pattern element 206 may thus be configured based on the minimum imaging distance and maximum imaging distance of the imaging device 200.

The baseline 222 and the pattern 204 may be engineered together with the desired sensor resolution in such a way that the pattern shift (e.g., in the distance range (d_{MIN}, d_{MAX})) may be smaller than the element-to-element distance (illustratively, the distance from an edge of a pattern element 206 to the edge of the adjacent pattern element 206 within the pattern 204).

According to various aspects, the adapted pattern of the emitted light may be combined with a controlled masking of the light sensor 216, as shown in FIG. 2E.

FIG. 2E shows pixel masking at the light detection system 214 in a schematic representation, according to various aspects. As mentioned above, the light sensor 216 may include a plurality of pixels 226 (referred to herein as receiver pixels, or sensor pixels). Illustratively, each pixel 226 may be configured to generate a corresponding signal (e.g., a current, such as a photo current) upon light impinging on the pixel 226. During detection, some of the pixels 226 may be masked according to the emitted light (e.g., according to the pattern 204) to reduce or prevent noise from other light sources (e.g., ambient light, other imaging devices, and the like).

In FIG. 2E, the masked pixels 228 are shown with a stripe pattern, whereas the active (non-masked) pixels 230 are shown with a white background. FIG. 2E shows two different scenarios 240a, 240b corresponding, respectively, to light received from a large distance (approximate to infinite) and light received from a shorter distance d1 (e.g., a distance for which saturation could occur in a conventional imaging device). In various aspects, the light sensor 216 may include a plurality of pixel groups each including a respective plurality of pixels 226, where the pixels composing the group are in proximity to each other, and where each group is distanced from other sensitive group of pixels by a light insensitive material.

In general, the masking of the pixels 226 may be implemented physically or electronically. In a physical implementation one or more physical masks may be used, e.g. the light detection system 214 may include one or more physical masks and a motion system configured to bring a mask in front of the pixels 226. The one or more physical masks may have one or more light-blocking regions (e.g., light-absorbing regions) to prevent light from impinging onto the masked pixels 228, and may have one or more light-transparent regions to allow light to impinge onto the active pixels 230.

In a preferred configuration, which may allow a more flexible masking, the masking may be carried out electronically, illustratively by switching “on” the pixels 230 to be active and by switching “off” the pixels 228 to be masked. The electronic masking may be implemented via an embedded software or via electronic controls.

According to various aspects, the imaging device 200 (e.g., as part of the light detection system 214) may include a controller configured to control the pixels 226 of the light sensor 216. The controller may be configured to activate the receiver pixels in accordance with the pattern 204 of the emitted light. Illustratively, the controller may be configured to activate (in other words, enable) the receiver pixels 230 onto which light 204r is expected to impinge in case of direct reflection of the emitted light. The active pixels 230 may thus correspond to expected arrival locations of reflected pattern elements 206r in case of direct reflection of the emitted pattern elements 206. Stated in a different fashion, the controller may be configured to activate one or more of the receiver pixels 230 based on an expected arrival position of light at the light sensor 216 in accordance with the predefined pattern 204 of the emitted light (e.g., in accordance with the spatial distribution of the pattern elements 206). In a Lambertian reflection, as an exemplary case, each point of the projected pattern on the target emits in all directions, so the target itself may be considered as an extended source that may be imaged in the sensor by the receiver optics (e.g., camera optics).

In an exemplary configuration, the controller may be configured to select a mask to be applied to the pixels 226 based on the distance range in which the imaging device 200 operates. The controller may thus be configured to change the mask of activated pixels 230 for different intervals of distance (e.g., for DTOF measurements), and each interval may be defined by a corresponding d_{MIN} and d_{MAX} as boundaries of any of such intervals. For example the imaging device 200 may include a memory (e.g., the storage 234) storing a plurality of masks, and the controller may be configured to retrieve a mask to be applied onto the receiver pixels 226 in accordance with the distance range.

In a corresponding manner, the controller may be configured to deactivate (in other words, disable, or electronically mask) the receiver pixels 228 onto which light 204r is not expected to impinge in case of direct reflection of the emitted light.

As shown in FIG. 2E, the adapted intensity profile of the emitted light ensures that in case of a spatial shift (in scenario 240b) a reduced intensity is imaged onto the active pixels 230. In the scenario 240a with reflection at a large distance, there may be substantially no shift, so that the intensity peak of a reflected light pattern 206r is imaged onto the active pixels 230 (whereas the tail is masked). In the scenario 240b with reflection at a relatively shorter distance d1, there may be a shift of f*BL/d1, and the decreasing intensity of the pattern element 206r ensures that the imaged intensity compensates for the closer distance from which the light is received.

According to various aspects, as shown in FIG. 2A, the imaging device 200 may include a processor 232 configured to control an operation of the imaging device 200 and/or to exchange data with the light emission system 202 and/or with the light detection system 214. The processor 232 may be coupled to storage 234 (e.g., a memory). The storage 234 may be configured to store instructions (e.g., software instructions) executed by the processor 232 and/or to store data received by the processor 232.

In general, the processor 232 may be configured to extract information from the light detected by the light detection system 214. The light detection system 214 may thus be configured to transmit light detection information (e.g., light sensing data) to the processor 232. Illustratively, the light detection system 214 may be connected to an underlying architecture that combines the different acquired signals. For example, the light detection system 214 may include an analog-to-digital converter configured to convert an analog signal representing the received light into a digital signal for processing by the processor 232.

In a preferred configuration, the processor 232 may be configured to determine (e.g., calculate) a time-of-flight of the emitted light, e.g. a time-of-flight of each pattern element 206. In a DTOF scenario, the light detection system 214 may include timing circuitry, e.g. a time-to-digital converter (or a plurality of time-to-digital converters, e.g. one per each pixel 226), configured to define a timestamp for the arrival time of light (photons) at the light sensor 216 (e.g., at each pixel 226, or active pixel 230). Based on the timing information, e.g. based on the different arrival times (depending on the different distances at which light was reflected), the processor 232 may be configured to generate a depth-map of the field of view 212 of the imaging device 200.

In general, there may be various possibilities for generating a light pattern, e.g. for emitting light having a desired intensity distribution. In the following, in relation to FIG. 3A to FIG. 4C, various strategies are described to emit light according to the non-uniform intensity distribution described in relation to FIG. 2A to FIG. 2E. The strategies described in the following have been found to provide a cost-and resource-efficient implementation of the adapted light emission described herein. It is however understood that, in principle, also other approaches to generate an adapted light pattern 204 or an adapted pattern element 206 may be provided.

FIG. 3A shows a light emission system 300 in a schematic representation, according to various aspects. The light emission system 300 may be for use in an imaging device, e.g. in the imaging device 200. In general, the light emission system 300 may include a light source 308 and emitter optics 310, and may be configured to emit light (e.g., infrared light) according to a predefined pattern 304, e.g. according to a pattern 304 including one or more pattern elements 306. Illustratively, the light emission system 300 may be an exemplary realization of the light emission system 202, e.g. of the corresponding light source 208, emitter optics 210, light pattern 204, and pattern element(s) 206.

In an exemplary configuration, the emitter optics 310 may be mechanically coupled to a substrate 302 on which the light source 308 is disposed (e.g., formed, or mounted). This arrangement may provide a robust configuration of the light emission system. For example, the substrate 302 may be or include a printed circuit board. For example, the plane of the emitter optics 310 may be disposed at a distance zo with respect to the plane of the light source 308. The distance of the emitter optics 310 from the light source 308 (e.g., from an array of sources of coherent light) may be selected to allow the projection of the structured light pattern 304. In an exemplary configuration, the distance zo may be defined as z₀=N*2*p²/λ, where N is an integer, p is the pitch of the emitter optics 310 (e.g., a distance between optical elements), and λ is the wavelength of the emitted light.

The light emission system 300 may be configured to emit the light pattern 304 and the pattern elements 306 via a superposition of a plurality of individual light signals (see also FIG. 3B). The light emission system 300 may thus be configured to generate a plurality of partial light signals and cause a superposition of the partial light signals to emit a pattern element having a light intensity profile with decreasing intensity in at least one direction. Illustratively, the light emission system 300 may be configured to generate and emit a plurality of individual light signals, whose superposition leads to the creation of the desired profile of the pattern elements 306 (e.g., at the far field with respect to the plane of the emitter optics 310).

As shown in FIG. 3B, the light emission system 300 may be configured to emit light according to the intensity profile of a pattern element 306 by generating and superimposing a plurality of individual light signals 306-1 . . . 306-N, e.g. a plurality of individual dots in case of the exemplary distribution in FIG. 3B. By adapting the light intensity of the individual light signals 306-1 . . . 306-N, the resulting pattern element 306 may have an intensity profile with decreasing intensity, as discussed in relation to FIG. 2A to FIG. 2D. The superposition of individual light dots may approximately provide a resulting intensity profile as shown in FIG. 2C. If r_{dot} is the angular dot radius of an individual dot 306-1 . . . 306-N, each generated dot pattern should be shifted by no more than r_{dot} with respect to the closest dot patterns to provide the desired superposition.

According to various aspects, for emitting a plurality of pattern elements 306, the light emission system 300 may be configured to generate a plurality of partial light patterns and cause a superposition of the plurality of partial light patterns. Illustratively, each partial light pattern may include a plurality of light signals, and the superposition of the light signals of the different partial light patterns provides pattern elements 306 having the desired light intensity profile. Further illustratively, each partial light pattern may include a plurality of partial pattern elements (e.g., each corresponding to a portion of the resulting pattern element 306), and the superposition of the partial pattern elements of different partial patterns provides resulting pattern elements 306 having the desired light intensity profile.

In an exemplary configuration, the light emission system 300 may be configured to generate, from a basic pattern, a plurality of partial patterns (e.g., at least two partial patterns) to be superimposed. The plurality of partial patterns may have a spatial shift with respect to one another, so as to shift the respective light signals (or partial pattern elements) and create the desired resulting spatial distribution of the light intensity. Illustratively, each partial pattern may have a spatial shift with respect to the adjacent partial pattern(s) along the at least one direction in which the intensity of a (resulting) pattern element 306 decreases. For example each partial pattern may have a spatial shift with respect to the adjacent partial pattern(s) in the direction of the baseline between the light emission system 300 and a light detection system of the imaging device. In a preferred configuration, the spatial shift between adjacent partial patterns may remain constant over the plurality of partial patterns. In another configuration, a varying spatial shift may be provided to provide further tailoring of the intensity profile of a pattern element 306.

As discussed in further detail in relation to FIG. 4A to FIG. 4C, each partial pattern may be generated by a corresponding zone (a corresponding region) of the light source 308 and/or by a corresponding zone of the emitter optics 310. The partial light patterns may have the same distribution of partial pattern elements (e.g., a same number of partial pattern elements, a same element-to-element distance, a same matrix disposition, and/or the like), with the presence of a spatial shift between partial light patterns.

In various aspects, different partial light patterns may have different light intensity, e.g. a scaling factor may be present between the light intensity of the partial pattern elements of different partial light patterns. The varying intensity may be adapted to provide the desired resulting intensity distribution for a pattern element. In general, considering a disposition of the partial patterns along the at least one direction, and considering the partial light pattern with the highest intensity as reference point, the light intensity of the other partial light patterns may decrease for increasing distance from the reference point.

Illustratively, considering a partial light pattern having the partial pattern elements with the highest intensity as reference pattern, a first partial pattern at a first spatial shift with respect to the reference pattern may have a first scaling factor for the light intensity of its partial pattern elements with respect to the partial pattern elements of the reference pattern. A second partial pattern at a second spatial shift with respect to the reference pattern may have a second scaling factor for the light intensity of its partial pattern elements with respect to the partial pattern elements of the reference pattern. In case the second spatial shift is greater than the first spatial shift (e.g., in the orientation in which the intensity of the resulting pattern element 306 should decrease), the second scaling factor and the first scaling factor may be such that the intensity of the partial pattern elements of the second partial pattern is less than the intensity of the partial pattern elements of the first partial pattern.

It is understood that the choice of the partial pattern with the highest intensity as reference point is arbitrary, and the considerations above apply in a corresponding manner considering other reference points. For example, considering a partial pattern at a position within the sequence of partial patterns (that is, not at one of the edges) as reference pattern, a first partial pattern having a spatial shift with respect to the reference pattern in the direction pointing towards the tail of the intensity profile of the resulting pattern element 306 may have a smaller light intensity compared to the reference pattern. A second partial pattern having a spatial shift with respect to the reference pattern in the direction pointing towards the head of the intensity profile of the resulting pattern element 306 may have a greater light intensity compared to the reference pattern.

In the following, with relation to FIG. 4A to FIG. 4C, possible strategies to generate partial light patterns having a spatial shift with respect to one another will be described. The approaches discussed in FIG. 4A to FIG. 4C may be implemented individually, or in combination with one another (e.g., a structured light source described in FIG. 4A may be combined with a structured imaging optics described in FIG. 4B, and/or with a structured prism described in FIG. 4C).

FIG. 4A shows a light source 400 in a schematic representation according to various aspects. The light source 400 may be an exemplary realization of the light source 208, 308 to generate a desired light pattern. In general, the light source 400 may be understood as a structured illuminator, and may include a plurality of emitters 402 (e.g., a plurality of VCSELs).

According to various aspects, the plurality of emitters 402 may be disposed in a plurality of emitter regions 404, e.g. first to sixth emitter regions 404-1 . . . 404-6 in the exemplary configuration in FIG. 4A. Illustratively, the emitter pixels 402 may be logically grouped or divided into respective emitter regions. Each emitter region may be associated with a corresponding partial light pattern, e.g. the emitters 402 of an emitter region may emit the corresponding partial light pattern.

The emitter regions 404 may be configured or controlled to emit light with different intensity, so as to provide partial light patterns whose superposition leads to the desired intensity profile of the resulting pattern element. In general, different emitter regions 404 may emit a different total optical power. For example, the total optical power of an emitter region corresponding to a partial light pattern closer to the head of the intensity profile of the resulting pattern element may be greater than the total optical power of an emitter region corresponding to a partial light pattern closer to the tail of the intensity profile of the resulting pattern element. The different total optical power may be provided by adapting the number of emitters 402 in the regions 404 and/or adapting the individual optical power of the region 404, as discussed below.

In a simple configuration, the emitters 402 forming an emitter region may be contiguous with one another. In another configuration, which allows an increased flexibility in the tailoring of the intensity distribution, the emitters 402 forming an emitter region may be non-contiguous, e.g. the emitters 402 corresponding to a partial light pattern may be disposed in a non-contiguous manner within the light source 400.

In an exemplary configuration, as shown in FIG. 4A, different emitter regions 404 may include different numbers of emitters 402 (illustratively, different numbers of emitter pixels). For example a first region 404-1 may include a first number N1 of emitters 402, a second region 404-2 may include a second number N2 of emitters 402, etc. The ratio in the number of emitters 402 may be selected according to the desired ratio between the respective emitted light intensities. For example, to provide ⅓ of the pattern intensity in the second region 404-2 the second number of emitters N2 may be selected such that N2=(N1)/3 (assuming that the individual emitter emit the same optical power).

As another exemplary configuration, which may be provided in addition or as an alternative to varying the number of emitters, the emitters 402 in different emitter regions 404 may be configured or controlled to emit different optical power. For example a first region 404-1 may include emitters 402 each emitting a first optical power P1, a second region 404-2 may include emitters 402 each emitting a second optical power P2, etc. The ratio in the optical powers may be selected according to the desired ratio between the respective emitted light intensities. For example, to provide ⅓ of the pattern intensity in the second region 404-2 the second optical power P2 may be selected such that P2=(P1)/3 (assuming that the regions include a same number of emitters 402). For example, the light emission system 400 may include a controller configured to control the emitters 402 in the different regions 404 to emit light according to a predefined optical power. For example, the light emission system 400 may include an individual controller or a plurality of dedicated controllers (e.g., one for each emitter region 404).

Varying the number of emitters 402 and varying the optical power may also be combined provided that the respective combination leads to the desired ratio in the resulting light intensity of the partial light patterns. Illustratively, considering the numerical example above, the number of emitters 402 and optical power of the second region 404-2 may be selected such that N2*P2=(N1*P1)/3.

The emitters 402 in the different emitter regions 404 may be disposed to provide a spatial shift between the respective partial light patterns (discussed in relation to FIG. 3A). For example, a regular lattice of zero-displacement positions and period Pref may be defined, where Pref may be an emitter-to-emitter distance. The emitters 402 in each emitter region 404 may be at a corresponding relative spatial shift (a corresponding relative displacement) with respect to the regular lattice. The spatial shift may be along the direction in which the intensity of a resulting pattern element decreases (e.g., along the X-direction in the XY plane defined by light emission system and light detection system). For example, the spatial shift may be smaller than Pref For example, the spatial shift may be a shift in the direction oriented away from a light detection system of the imaging device. The spatial shift may also be greater than Pref, which may lead to the corresponding partial pattern rolling back into the initial one. Illustratively, the pattern angular displacement may be proportional to A mod Pref. Two regions may also differ by having spatial shifts in opposite oriented directions.

In the exemplary configuration in FIG. 4A the emitters 402 of the first emitter region 404-1 may be at a fist displacement Δ1=0 with respect to the reference lattice. The emitters 402 of the second emitter region 404-2 may be at a second displacement Δ2>Δ1 with respect to the reference lattice. The emitters 402 of the third emitter region 404-3 may be at a third displacement Δ3>Δ2 with respect to the reference lattice, etc. It is understood that this configuration is exemplary, and other pixel arrangements may be provided to generate partial light patterns with a relative spatial shift.

According to various aspects, the emission of a fading pattern may be combined with a non-tailored emission to adapt the detection strategy to different distance ranges. In case a fading pattern is emitted to compensate for the effects described above, for the same total emitted power, the emitted power at the head of the intensity profile is reduced as compared as the case in which a sharp light distribution (e.g., a perfect dot, or a single partial pattern element) is emitted, e.g. a light distribution with a sharp peak (illustratively, a localized light distribution). In various aspects, the controller of the light source 400 may be configured to switch between an emission of pattern elements with a fading light intensity distribution and an emission of pattern elements with a sharp light intensity distribution.

For example, for detection in a first distance range the controller may be configured to control the light source 400 (the emitters 402) to emit pattern elements with a sharp light intensity distribution. In this scenario, the controller may be configured to control the light source 400 by allocating all current to one of the emitter regions, e.g. to the source plane 404-1. The boundaries dₘᵢₙ and dₘₐₓ of the first distance range may be both approximated to infinity (far field). For detection in a second distance range the controller may be configured to control the light source 400 (the emitters 402) to emit pattern elements with a fading light intensity distribution. In this scenario, the controller may be configured to control the light source 400 by allocating current to the emitter regions as discussed above. The boundaries dₘᵢₙ and dₘₐₓ of the second distance range may be at near field, e.g. may not be approximated as infinity. Illustratively, the second distance range may include distances closer to the light source 400 (and to the imaging device) with respect to the distances of the first distance range.

In case the maximum total emitted power is limited by the maximum current that the light source driver (e.g., the laser diode driver, LDD) may provide, it may be possible to reconfigure the light source driver to only provide current to one region of emitters 402 (e.g., the first region 404-1) and as such to provide maximum current to the single dot for the far field. For example, in a first detection window the controller may be configured to control the light source 400 to emit pattern elements with a sharp light intensity distribution. In a second detection window (e.g., before or after the first detection window) the controller may be configured to control the light source 400 to emit pattern elements with a fading light intensity distribution (illustratively, the intensity distribution described in relation to FIG. 2A to FIG. 2E).

This configuration may lead to an additional complexity for firmware to reconfigure the light source driver between windows but may provide the advantage not to reduce the maximum detectable distance with the same integration time/power budget since the energy is spread to cope with short distance objects.

FIG. 4B shows a structured emitter optics 410 in a schematic representation, according to various aspects. Additionally or alternatively to the structuring of the light source discussed in FIG. 4A, a structuring of the emitter optics 410 may be provided to generate a plurality of partial light patterns.

In this configuration, the emitter optics 410 may include a plurality of lens elements 412 disposed in a plurality of lens regions 414, e.g. first to sixth lens regions 414-1 . . . 414-6 in the exemplary configuration in FIG. 4B. Illustratively, the lens elements 412 may be logically grouped or divided into respective lens regions. Each lens region may be associated with a corresponding partial light pattern, e.g. the lens elements 412 of a lens region 414 may direct light towards the field of view to generate a corresponding partial light pattern. In combination with the structured light source 400, each of the emitters 402 may illuminate one or more lens elements 412, e.g. a plurality of lens elements 412.

In a preferred configuration, the emitter optics 410 may be or include a micro-lens array (MLA). Illustratively, in this configuration, the plurality of lens elements 412 may be a plurality of micro-lenses disposed in different regions of the array.

Analogously to the discussion for the light source 400, the lens regions 414 may include a different number of lens elements 412, so that the partial light patterns associated with different lens regions 414 may have varying light intensity. For example, a first lens region 414-1 may include a first number N1 of lens elements 412, a second lens region 414-2 may include a second number N2 of lens elements 412, etc. The ratio in the number of lens elements 412 may be selected according to the desired ratio between the respective emitted light intensities. For example, to provide ⅓ of the pattern intensity in the second lens region 414-2 the second number of lens elements N2 may be selected such that N2=(N1)/3.

The lens elements 412 in the different lens regions 414 may be disposed to provide a spatial shift between the respective partial light patterns (discussed in relation to FIG. 3A). For example, a regular lattice of zero-displacement positions and period Pref may be defined (e.g., in an analogous manner as for the light source 400, e.g. the same regular lattice may be defined for both the light source 400 and emitter optics 410), where Pref may be a lens-to-lens distance. The lens elements 402 in each lens region 414 may be at a corresponding relative spatial shift (a corresponding relative displacement) with respect to the regular lattice. The spatial shift may be along the direction in which the intensity of a resulting pattern element decreases (e.g., along the X-direction in the XY plane defined by light emission system and light detection system), for example with orientation pointing towards a light detection system of the imaging device. Two regions may differ by having a spatial shift in opposite oriented directions.

In the exemplary configuration in FIG. 4B the lens elements 412 of the first lens region 414-1 may be at a fist displacement Δ1=0 with respect to the reference lattice. The lens elements 412 of the second lens region 414-2 may be at a second displacement Δ2>Δ1 with respect to the reference lattice. The lens elements 412 of the third lens region 414-3 may be at a third displacement Δ3>Δ2 with respect to the reference lattice, etc. It is understood that this configuration is exemplary, and other arrangements of the lens elements may be provided to generate partial light patterns with a relative spatial shift.

In each individual region 414, all the lens elements 412 may have the same shift Δ (e.g., along the X direction), with respect to the reference (square) lattice. For example, the spatial shift may be a smaller than Pref (or greater than P_{ref}, as mentioned above). The elements of the same region may be spatially not-connected (e.g., two spatially separated sub-regions of the full MLA, with the same shift Δ, may still be considered as part of the same region). A lens region 414 may thus be characterized by the number of lens elements 412 that are part of the region, and by the shift 4.

FIG. 4C shows a prism arrangement 420 in a schematic representation, according to various aspects. In addition or in alternative to a structured light source 400 and/or a structured imaging optics 410, a light emission system may include a prism arrangement 420 including a plurality of prism element 422 to generate the partial light patterns. A prism element 422 may be configured to direct light emitted by the light source towards the field of view. In the exemplary representation in FIG. 4C, the prism arrangement 420 is shown together with a structured emitter optics 410, but it is understood that the prism arrangement 420 may also be provided with emitter optics not structured as described in relation to FIG. 4B.

The prism elements 422 may be disposed in a plurality of prims regions 424, e.g. first to fourth prims regions 424-1 . . . 424-4 in the exemplary configuration in FIG. 4C. Each prims region may be associated with a corresponding partial light pattern, e.g. the prism elements 422 of a prism region 424 may direct light towards the field of view to generate a corresponding partial light pattern.

In each prism region 424, the prism facet of the respective prism elements 422 may be tilted by a respective tilting angle, e.g. with respect to the direction in which the intensity of the resulting pattern element decreases (e.g., the prism facets may be tilted with respect to the X direction). The tilting direction and orientation of a given element may illustratively be related to the direction and orientation of the XY-plane-projection of a vector orthonormal to the prism facet. Illustratively, the prism arrangement 420 may be a prism array, whose area is divided in regions 424, and each region 424 may be characterized by the tilting angle θ, tilting direction, and/or tilting orientation of the prism facet. There may be various ways to configured the prism elements 422 (e.g., in terms of tilting angle, tilting direction, tilting orientation, and/or number of prism elements 422 in a region) to provide (e.g., generate) the desired light pattern, as discussed in further detail below.

As an example, the tilting angle may increase (from one prism region to the next) along the direction in which the intensity of a resulting pattern element decreases. For example, in a preferred configuration, the tilting angle may increase along the direction oriented pointing away from the light detection system of the imaging device (illustratively, the tilting angle may increase along the direction oriented towards the head of the pattern element). Each prism region may steer the fraction of the pattern generated by the optics below its own region (e.g., by a corresponding region of the structured optics 410) by a different angle.

In some other configurations the tilting angle may increase (from one prism region to the next) along the direction in which the intensity of a resulting pattern element increases (and, for example, the number of prism elements 422 may decrease accordingly). As another example, different prism regions (or non-contiguous portions of a same prism region) may include prism elements 422 oriented in opposite directions.

In a simple configuration, the prism elements 422 forming a prism region may be contiguous with one another. In another configuration, which allows an increased flexibility in the tailoring of the intensity distribution, the prism elements 422 forming a prism region may be non-contiguous, e.g. the prism elements 422 corresponding to a partial light pattern may be disposed in a non-contiguous manner within the prism arrangement 420.

According to various aspects, the prism regions 424 may have a different number of prism elements, or elements of different sizes covering different size areas of the illuminator emitter face. In a preferred configuration described above, the number of prism elements 422 of a prism region, or the area of the corresponding prism region, may decrease for increasing tilting angle, e.g. may decrease along the direction in which the intensity of a resulting pattern element decreases (e.g., the number of prism elements may decrease along the direction oriented pointing away from the light detection system of the imaging device). In combination with structured emitter optics 410, each prism region 424 may cover a respective region of the emitter optics 410 (e.g., may cover a respective number of lens elements 412, e.g. MLA elements).

It is understood that the described example is representative, and may be straightforwardly generalized to any optical component or combination of (e.g., diffractive) optical elements configured to shift the partial dot pattern in a controlled way depending from some design parameter (the tilting angle, in the prism array case). Such design parameter may be modified for each region to obtain the same type of pattern.

In various aspects, a light emission system may include a structured light source 408, and a structured imaging optics 410, and a structured prism arrangement 422. The pattern produced by all light sources (all emitters 402) that are part of a region (as defined above), that illuminate a region of lenses 412 of the plane of the emitter optics 410 (e.g., MLA plane), for a given tilting angle of the prism facets (absence of the prism corresponds to θ=0) may be a regular pattern of dots. The superposition of the pattern of dots results in pattern elements with the desired intensity profile. The combination of the three values of spatial shift of the lens elements, spatial shift of the emitters, and/or tilting angle θ defines the pattern shift and the number of elements of each type contributes to define the pattern contrast. The combined contribution of different regions results in additional dot patterns differing from the first one by a shift. In an alternative, simpler, configuration regions are defined in only one of the three elements (the emitters, or the lenses, or a prism array).

The element (e.g., MLA or VCSEL) shift, or alternatively the prism array facet angle values change from one region to another only in one direction (e.g., the sensor baseline direction), and define the shift of each additional dot pattern. The number of elements in each region or, in case that elements of different regions have different emission power or size, the total optical power emitted by (for sources), or propagating through (for microlenses and prism arrays) all the elements of the corresponding region, defines the intensity of each additional dot pattern. The dot pattern shift generated within each region overlaps dots generated in one or more other regions. For example, the shift and intensity of each additional generated pattern may be specified in such a way that the sum of partially overlapped dots approximate a power-law decaying tail, with a given exponent. In various aspects, the shifts (controlled by Δ and θ) and the contrast and the number of element may be such that a power-law decaying tail is approximated by overlapping discrete dot patterns, where the power-law tail distribution is on the sensor side of the X axis.

A “depth measurement” may be a measurement configured to deliver three-dimensional information (illustratively, depth information) about a scene, e.g. a measurement capable of providing three-dimensional information about the objects present in the scene. A “depth measurement” may thus allow determining (e.g., measuring, or calculating) three-dimensional coordinates of an object present in the scene, illustratively a horizontal-coordinate (x), vertical-coordinate (y), and depth-coordinate (z). A “depth measurement” may be illustratively understood as a distance measurement configured to provide a distance measurement of the objects present in the scene, e.g. configured to determine a distance at which an object is located with respect to a reference point.

The term “processor” or “processing circuit” as used herein may be understood as any kind of technological entity that allows handling of data. The data may be handled according to one or more specific functions that the processor or processing circuit may execute. Further, a processor or processing circuit as used herein may be understood as any kind of circuit, e.g., any kind of analog or digital circuit. A processor or processing circuit may thus be or include an analog circuit, digital circuit, mixed-signal circuit, logic circuit (e.g., a hard-wired logic circuit or a programmable logic circuit), microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. It is understood that any two (or more) of the processors or processing circuits detailed herein may be realized as a single entity with equivalent functionality or the like, and conversely that any single processor or processing circuit detailed herein may be realized as two (or more) separate entities with equivalent functionality or the like.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ] , etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

While the above descriptions and connected figures may depict electronic device components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes, which come within the meaning and range of equivalency of the claims, are therefore intended to be embraced.

### LIST OF REFERENCE SIGNS

100 Time-of-flight sensor
102 Light emission system
104 Light detection system
106 Processing circuit
108 Emitted light
110 Object
112 Reflected light
120a Graph
120b Graph
122 Maximum capacity
124 Linear regime
126 Saturated regime
130a Graph
130b Graph
132 Data points
134 Data points
140a Graph
140b Graph
142 Accuracy
144 Precision
146 Dot at 300 mm distance
148 Dot at 1000 mm distance
200 Imaging device
202 Light emission system
204 Light pattern
204r Reflected light
206 Pattern element
206a Pattern element
206b Pattern element
206c Pattern element
206d Pattern element
206e Pattern element
206f Pattern element
206r Reflected pattern element
206-1Pattern element
206-2Pattern element
208 Light source
210 Emitter optics
212 Field of view
214 Light detection system
216 Light sensor
218 Receiver optics
220 Object
222 Baseline
224a Direction
224b Direction
224c Direction
224d Direction
224e Direction
224f Direction
225 Optical axis
226 Receiver pixels
227 Optical axis
228 Masked pixels
230 Active pixels
232 Processor
234 Storage
240a Detection scenario
240b Detection scenario
250 Inset
300 Light emission system
302 Substrate
306 Pattern element
306-1Partial pattern element
306-2Partial pattern element
306-3Partial pattern element
306-4Partial pattern element
306-5Partial pattern element
306-6Partial pattern element
308 Light source
310 Emitter optics
400 Structured light source
402 Emitter
404 Emitter region
404-1First emitter region
404-2Second emitter region
404-3Third emitter region
404-4Fourth emitter region
404-5Fifth emitter region
404-6Sixth emitter region
410 Structured emitter optics
412 Lens element
414 Lens region
414-1First lens region
414-2Second lens region
414-3Third lens region
414-4Fourth lens region
414-5Fifth lens region
420 Prism arrangement
422 Prism element
424 Prism region
424-1First prism region
424-2Second prism region
424-3Third prism region

1. An imaging device comprising:
a light emission system configured to emit, in a field of view of the imaging device light according to a predefined light pattern,
wherein at least one pattern element of the predefined light pattern has a light intensity profile with a decaying intensity in at least one direction; and
a light detection system configured to detect light in the field of view of the imaging device,
wherein the at least one direction corresponds to a direction of a baseline between the light emission system and the light detection system,
wherein the at least one pattern element has a maximum intensity around a first edge of the at least one pattern element, and the intensity of the at least one pattern element gradually decreases down to a minimum intensity at a second edge of the at least one pattern element, and
wherein the second edge is opposite the first edge along the at least one direction.

2. The imaging device according to claim 1, wherein the light intensity profile of the at least one pattern element has an elongated shape in the at least one direction.

3. The imaging device according to claim 1, wherein the intensity of the at least one pattern element decays according to a power law with a predefined exponent.

4. The imaging device according to claim 1, wherein the decay of the light intensity of the at least one pattern element is configured to compensate for a distance related shift of the at least one pattern element and for a distance-related variation of the light intensity of the at least one pattern element.

5. The imaging device according to claim 1, wherein the light emission system is configured to:
generate a plurality of partial light patterns; and
cause a superposition of the partial light patterns to emit light according to the predefined pattern.

6. The imaging device according to claim 5,
wherein the partial light patterns have a spatial shift with respect to one another; and
wherein the partial light patterns have different light intensity with respect to one another.

7. The imaging device according to claim 5, wherein the light emission system comprises:
a light source comprising a plurality of emitters;
wherein the emitters are disposed in a plurality of emitter regions, and wherein each emitter region is associated with the emission a corresponding partial light pattern.

8. The imaging device according to claim 5, wherein the light emission system comprises:
a plurality of lens elements disposed in a plurality of lens regions,
wherein each lens region is associated with the emission of a corresponding partial light pattern.

9. The imaging device according to claim 5, wherein the light emission system comprises:
a plurality of prism elements disposed in a plurality of prism regions,
wherein each prism region is associated with the emission of a corresponding partial light pattern.

10. The imaging device according to claim 1, wherein the light detection system comprises:
a light sensor comprising a plurality of receiver pixels; and
a controller configured to activate the receiver pixels in accordance with the predefined pattern of the emitted light.

11. The imaging device according to any one of claim 1, further comprising:
a processor configured to receive light detection information from the light detection system and to determine a time-of-flight of the emitted light based on the received light detection information.

12. The imaging device according to claim 1, wherein the at least one pattern element has a light intensity profile with a decaying intensity in a direction oriented pointing from the light emission system towards the light detection system.

13. The imaging device according to claim 1, wherein the at least one pattern element has a light intensity profile with an intensity that decays monotonically along the at least one direction.
